(19) United States
(12) Patent Application Publication
(10) Pub. No.: US 2012/0184223 A1
(43) Pub. Date: Jul. 19, 2012

(54) RADIO NETWORK COMPRISING RADIO CLIENTS THAT PERFORM CHANNEL MEASUREMENTS IN A DIAGNOSTIC MODE

(75) Inventors: Frank Hakemeyer, Horn-Bad Meinberg (DE); Stefan Witte, Minden (DE)

(73) Assignee: PHOENIX CONTACT GMBH & CO. KG, Blomberg (DE)

(21) Appl. No.: 13/496,728

(22) PCT Filed: Sep. 17, 2010
(86) PCT No.: PCT/EP2010/063719

§ 371 Date: Mar. 16, 2012

(30) Foreign Application Priority Data
Sep. 18, 2009 (DE) 10 2009 041 835.0

(51) Int. Cl. H04W 24/00

(52) U.S. Cl. 455/67.11

(57) ABSTRACT

The invention relates to a radio network (1) comprising a first radio client (2) and at least one second radio client (3a, 3b, 4a, 4b, 4c), wherein the first radio client (2) and the at least one second radio client (3a, 3b, 4a, 4b, 4c) can communicate with one another within a frequency band on at least two channels by means of radio waves, where the second radio client (3a, 3b, 4a, 4c) is configured such that said client can be switched to a diagnostic mode, wherein the second radio client (3a, 3b, 4a, 4b, 4c) runs through at least two channels within the frequency band in the diagnostic mode and receives a measurement signal on the respective channel, wherein the measurement signal reflects the strength of a radio wave received from the second radio client (3a, 3b, 4a, 4b, 4c).

Networks with a plurality of clients which are able to communicate with each other are generally know. The clients can be positioned within the network in different logical structures, and it is known to so arrange them that they form a tree structure. In a tree structure, one client stands at the top, while the other clients are connected to this client. The client at the top of the tree structure is a part of the uppermost, first network level; the clients directly connected to this client belong to a second network level subordinate to the first network level; the clients directly connected to these latter clients are part of a third network level subordinate to the second network level, and so on. In a tree structure, connections are only permitted between clients of neighboring network levels. Connections within one network level are not permitted. Apart from the client at the top of the tree structure, furthermore, a client is directly connected to a client of an adjacent, superordinate network level. Moreover, a plurality of clients on a subordinate network level can be connected to a single client of an adjacent subordinate network level.

The clients of a network are referred to as “network nodes” or “nodes”. A distinction is also made between master clients, repeater-slave clients, and slave clients. The master client forms the central point of the network. Network-specific functions are performed by the master client. The network is unable to operate without a master client. In a tree structure, the client at the top is a master client. The function of a repeater-slave client is to conduct information between adjacent clients. A slave client does not transmit information. Slave clients always form the terminal point of a network.

The prior art is well acquainted with different kinds of radio networks, for example, wireless LAN or WLAN. As a rule, the indicated radio networks communicate according to the standard IEEE 802.11. To at least estimate the quality of communication within the radio network between clients of the radio network, it is known to measure the so-called RSSI signal (received signal strength indicator) for a radio client. The RSSI signal is a measure of the field strength of radio waves at the location of the radio client. The value of the RSSI signal is dependent on the output of the transmitter sending the radio waves, on the path attenuation between transmitter and receiver, and on the transmission of other radio waves on the same frequency or in the same frequency band.

Customarily the output is a constant magnitude, while the path attenuation varies to a high degree with the frequency, time, and location. The influence of frequency plays a role particularly in the case of frequency-jumping networks, i.e., radio networks whose clients continuously modify their transmission and reception frequency. The influence of time and location is conditioned by changing fields. Transmission from radio sources in the same frequency band is another influence that must be taken into account. The result is that the RSSI signal is subject to serious fluctuations. As a one-dimensional magnitude, the RSSI signal is frequently a mean value across all jump-frequencies and a time interval x.

The invention is based on the problem of creating a radio network which permits an improved and expanded detection of the field strengths of radio waves within the given radio network.

This problem is solved with a radio network according to independent claim 1. Advantageous embodiments of the invention are specified in the secondary claims.

The radio network according to the invention comprises an initial radio client and at least one second radio client, such that the first radio client and the one or more second radio clients are able to communicate with each other using radio waves on at least two channels within a single frequency band. The second radio client is so designed that it can be switched into a diagnostic mode. In the diagnostic mode the second radio client runs through at least two channels within the frequency band and on the given channel receives a measuring signal that expresses the strength of a radio wave received by said second radio client.

A “channel” is understood to be a narrow-band frequency band around a carrier frequency, on which band the first radio client and the one or more second radio clients can communicate with each other.

For different channels, the measurement signal received by the one or more second radio clients makes it possible to determine the quality of transmission on the given channel. Communication can take place directly between the first radio client and the one or more second radio clients, or other second radio clients can be interposed so that communication takes place indirectly over the interposed second radio client. Furthermore, the first and second radio clients can communicate either on a common channel or on different channels. For example, if the first radio client communicates with a second radio client on channel 1, this second radio client may communicate with another second radio client on a channel 2, which is different from channel 1.

The radio network according to the invention makes it possible to receive a measurement signal for different channels at the location of the one or more second radio clients, and this measurement signal expresses the strength of a radio wave received by the second radio client. The measurement signal can be either an instantaneous measurement signal or a measurement signal averaged over time. Likewise, it possible to receive the measurement signal not only as a function of channel but also of time. In this manner it is possible to gain comprehensive information for use in evaluating the quality of radio connections inside of the radio network. Inasmuch as the one or more second radio clients themselves are used for the reception of such measurement signals, the reception of the measurement signals can be operated with little or no additional expenditure in terms of hardware.

The two or more channels on which a measurement is performed can be channels on which the network communicates or channels that are not used for communication. A combination is also possible.

In one advantageous embodiment, the one or more second radio clients are so designed that the client can be switched from a communication mode into the diagnosis mode and back into communication mode, such that the one or more second clients can communicate with radio clients in the communication mode, while communication with other radio clients is suspended in the diagnosis mode.

The separation between the communication mode and the diagnosis mode makes it possible for the one or more second radio clients to use at least a portion of the hardware components in both communication mode and diagnosis mode. This eliminates the duplication of hardware components, e.g., antennas, transmission units, reception units, and control and evaluation devices. Hardware expenditure can thereby be minimized.

The radio network can use the measurement signals received by the one or more radio clients in order to optimize said radio network. For example, the measurement signals received by the one or more second radio clients can be analyzed to determine whether there are foreign transmission sources that might disturb radio traffic within the radio network. In an advantageous elaboration of the radio network, e.g., one or several channels for communication between radio clients can be blocked on the basis of the received channel-dependent measurement signals. Thus the radio network will be prevented from communicating on channels that are disrupted by foreign transmission sources. This allows the radio network to coexist with other transmitters. The blocking of individual channels may take place globally for the entire radio network or only locally for the affected radio clients of the radio network.

In an advantageous elaboration, the one or more second radio clients transmit the received channel-dependent and (as the case may be) time-dependent measurement signals to the first client. In this way it is ensured that the measurement signals of all second radio clients are present to the first radio client. This makes possible the simple call-up of measurement signals, a comparison of the measurement signals of different second radio clients, and the performance of further measures, if so required.

The first radio client will advantageously be a master client. In particular, the master client can establish the channels that are used for communication inside the radio network and is able to block those channels that are identified as unsuitable for communication.

The invention will next be described in greater detail on the basis of preferred embodiments and with reference to the attached drawings.

Shown are:

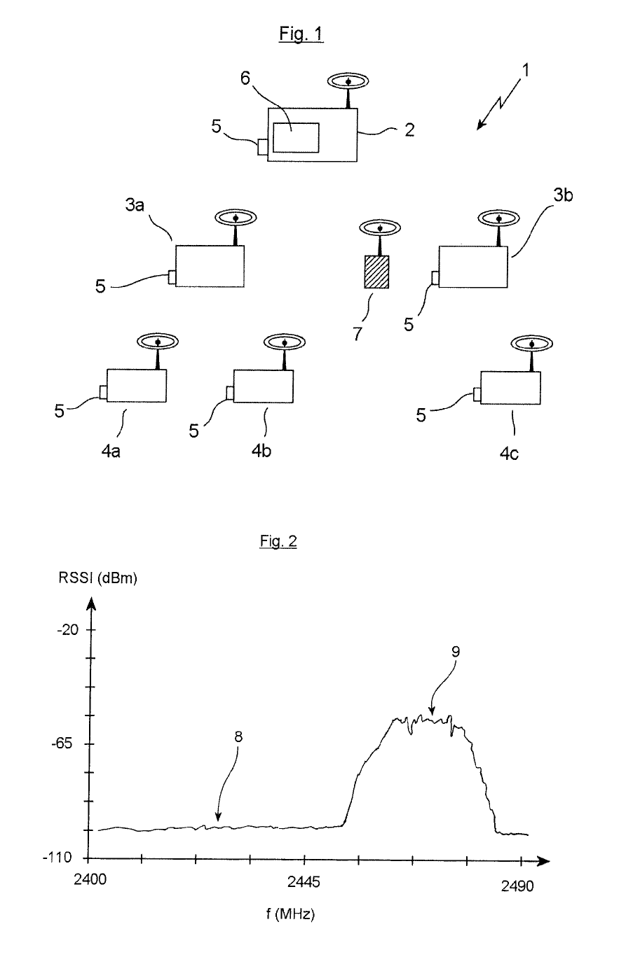

FIG. 1: a schematic depiction of an embodiment of a radio network according to the invention

FIG. 2: an exemplary depiction of a measurement signal received by a second radio client of the radio network shown in FIG. 1.

FIG. 1 provides a schematic depiction of an embodiment of the radio network according to the invention.

The radio network 1 comprises a first radio client 2 and a total of five second radio clients 3a, 3b, 4a, 4b, 4c. The radio network 1 is configured according to a tree structure, such that the first client 2 is located at the top, in a first network level of the tree structure 1; two second clients 3a, 3b are located in a second network level adjacent and subordinate to the first network level; and the last three second clients 4a, 4b, and 4c are located in a third network adjacent and subordinate to the second network level. Communication among the clients of the radio network 1 can occur between the first client 2 and the second client 3a; between the first client 2 and the second client 3b; between the second client 3b and the second client 4c; between the second client 3a and the second client 4a; and between the second client 3a and the second client 4b. Communication between, e.g., the first client 2 and the second client 4a occurs indirectly via the second client 3a. Communication between, e.g., the first client 2 and the second client 3a occurs directly.

The number of the second radio clients 3a, 3b, 4a, 4b, 4c and the varying arrangement in the different network levels are given merely by way of example. Other network levels, e.g., can be integrated into the radio network 1, along with other second clients.

The radio network 1 is designed so that the radio clients 2, 3a, 3b, 4a, 4b, 4c can communicate by means of radio waves within a frequency band on at least 20 channels. For example, there can be provided a frequency band of 2400 MHz to 2490 MHz, on which 50 channels are equally distributed. A channel is defined as a frequency band which is narrowly formed around a carrier frequency, as compared to the indicated frequency band. Given the plurality of channels available to the radio network 1, individual pairs of radio clients can communicate on different channels or can change to a different channel for the purpose of communication. This makes it possible, e.g., to prevent two pairs of radio clients within the network 1 from communicating on the same channel and thereby interfering with each other. Furthermore, it prevents communication within the network 1 from being completely blocked when one or more channels are disturbed, e.g., by a foreign transmitter or by local conditions.

The first client 2 is designed as a master client. The first client 2 is the central point of the network 1 and executes network-specific functions. The second clients 3a, 3b connected directly to the first client 2 are designed as repeater-slave clients. The specific function of the repeater-slave clients is to conduct messages between the network levels. The clients 4a, 4b, 4c of the third network level, which are connected to the second clients 3a, 3b of the second network level, are designed as slave clients.

The network 1 is designed so that at least one of the second radio clients 3a, 3b, 4a, 4b, 4c can be switched into a diagnosis mode. In the diagnosis mode the one or more second radio clients 3a, 3b, 4a, 4b, 4c run through at least 2 channels within the frequency band and, on the given channel, receive a measurement signal that is a function of channel and/or time, such that the measurement signal expresses the strength of a radio wave received by the second radio client 3a, 3b, 4a, 4b, 4c.

Switching into the diagnosis mode can be advantageously initiated by the first radio client 2. As an alternative, switching into diagnosis mode can be initiated by a local event, e.g., the pressing of a switch, or by a superimposed application. Moreover, all second radio clients 3a, 3b, 4a, 4b, 4c can be switched into the diagnosis mode in this exemplary embodiment. In particular, the second radio clients 3a, 3b, 4a, 4b, 4c are switched into diagnosis mode from the communication mode, in which the radio client is able to communicate with the other radio clients. After expiration of a predetermined period of time, the second radio clients 3a, 3b, 4a, 4b switch back from diagnosis mode into communication mode. A new notification occurs in the network 1. It is possible to switch over only a single second radio client 3a, 3b, 4a, 4b, 4c, or several, or all second radio clients 3a, 3b, 4a, 4b, 4c. Here the diagnosis modes of second radio clients 3a, 3b, 4a, 4b, 4c may overlap in time.

The measurement signal in this exemplary embodiment is an RSSI signal. The second radio clients 3a, 3b, 4a, 4b, 4c are designed so that in diagnosis mode the two or more channels are run through one or more times. Running through the channels can cover the entire frequency band or only over a section thereof. Or it may be limited to the channels that are used by the network 1 for communication. Furthermore, the channels which are run through in diagnosis mode can be restricted to a portion of the channels that are used for communication in the network 1. The measurement signals are filed in a storage belonging to the given second radio client 3a, 3b, 4a, 4b, 4c.

After gathering the measurement signals, the received signals are communicated to the first radio client 2. To this end, when the measurement is complete the second radio client returns from diagnosis mode to communication mode, which the second radio client then uses to communicate the measurement signals to the first radio client 2.

The first radio client 2 has an indicator unit 6, by means of which the frequency-dependent measurement signals of a second radio client 3a, 3b, 4a, 4b, 4c can be represented. This unit can be designed as, e.g., a display. In particular, the first client 2 can be designed so that the measurement signals of different second radio clients 3a, 3b, 4a, 4b, 4c can be displayed in superimposed fashion.

In this exemplary embodiment, furthermore, both the first client 2 and the second clients 3a, 3b, 4a, 4b, 4c include an interface 5, by means of which the received measurement signals can be read off, e.g., by connecting a suitable display unit, laptop, or another diagnostic tool.

In this exemplary embodiment the radio network 1 is designed so that one or more channels for communication between the radio clients 2, 3a, 3b, 4a, 4b, 4c can be blocked on the basis of the received frequency-dependent measurement signals. This can occur, e.g., when a foreign transmitter 7 transmits on one or more channels that are also used by the radio network 1.

The foreign transmitter 7 can be, e.g., a WLAN, which transmits in the frequency band from 2450 to 2470 MHz. This activity 9 by the foreign transmitter 7 is recorded by the measurement signals 8 received over the entire frequency band from a second radio client 3a, 3b, 4a, 4b, 4c operating in a diagnosis mode (see FIG. 2). If the measurement signals received by all second radio clients 3a, 3b, 4a, 4b, 4c show this disturbance in the frequency range from 2450 to 2470 MHz, the information can be used to exclude said frequency range from use by the network 1. In this way it is possible to improve the coexistence of the network 1 with one or more foreign transmitters 7.

### LIST OF REFERENCE NUMERALS

1 network
2 first client
3a, 3b, 4a, 4b, 4c second client
5 interface
6 display unit
7 foreign transmitter
8 measurement signal
9 activity of foreign transmitter

1-13. (canceled)

14. Measuring device for the signal strengths of a radio wave in a frequency band, with a radio network (1) comprising a first radio client (2) and a plurality of second radio clients (3a, 3b, 4a, 4b, 4c), where the first radio client (2) and each second radio client (3a, 3b, 4a, 4b, 4c) inside a frequency band can communicate one with the other on at least two channels by means of radio waves, and where each second radio client (3a, 3b, 4a, 4b, 4c) is so designed that it can be switched into a diagnosis mode, such that in the diagnosis mode the second radio client (3a, 3b, 4a, 4b, 4c) runs through at least two channels inside the frequency band and on the given channel picks up a measurement signal such that the measurement signal reflects the strength of a radio wave received by the second radio clients (3a, 3b, 4a, 4b, 4c), wherein
the radio network (1) is so designed that each second radio client (3a, 3b, 4a, 4b, 4c) communicates the received frequency-dependent measurement signals to the first radio client (2),
the first radio client (2) has a display unit (6), such that the frequency-dependent measurement signals of the second radio clients (3a, 3b, 4a, 4b, 4c) can be depicted by the display unit (6), and
the first radio client (2) is so designed that the measurement signals of the different second radio clients (3a, 3b, 4a, 4b, 4c) can be displayed in superimposed fashion.

15. Measuring device according to claim 14, where each second radio client (3a, 3b, 4a, 4b, 4c) is so configured that it can be switched from a communication mode into the diagnosis mode and back into the communication mode, and each second radio client (3a, 3b, 4a, 4b, 4c) can communicate with the radio clients (2, 3a, 3b, 4a, 4b, 4c) in the communication mode, and in the diagnosis mode the communication with other radio clients (2, 3a, 3b, 4a, 4b, 4c) is suspended.

16. Measuring device according to claim 15, where each second radio client (3a, 3b, 4a, 4b, 4c) is so designed that after the expiration of a predetermined period of time said radio client (3a, 3b, 4a, 4b, 4c) switches from the diagnosis mode back into the communication mode.

17. Measuring device according to claim 14, where each second radio client (3a, 3b, 4a, 4b, 4c) is so designed that in the diagnosis mode the two or more channels are run through a number of times.

18. Measuring device according to claim 14, where the measurement signal is an RSSI (received signal strength indictor) signal.

19. Measuring device according to claim 15, so configured that each second radio client (3a, 3b, 4a, 4b, 4c) switches into the communication mode and communicates the measurement signals to the first radio client (2) while in the communication mode.

20. Measuring device according to claim 14, where the first radio client (2) and/or at least one of the second radio clients (3a, 3b, 4a, 4b, 4c) has an interface (5) by means of which the received measurement signals can be read off.

21. Measuring device according to claim 14, where the first radio client (2) is a master client and the one or more second radio clients (3a, 3b, 4a, 4b, 4c) are repeater-slave clients or slave clients.

22. Measuring device according to claim 14, where the radio network (1) is designed according to a tree structure.

23. Process for measuring the signal strengths of a radio wave in a frequency band, with a radio network (1) comprising a first radio client (2) and a plurality of second radio clients (3a, 3b, 4a, 4b, 4c), where the first radio client (2) and each second radio client (3a, 3b, 4a, 4b, 4c) can communicate with each other inside of a frequency band on at least two channels by means of radio waves, and where each second second radio client (3a, 3b, 4a, 4b, 4c) can be switched into a diagnosis mode, such that in the diagnosis mode the second radio client (3a, 3b, 4a, 4b, 4c) runs through at least two channels within the frequency band and receives a measurement signal on the given channel, and the measurement signal reflects the strength of a radio wave received by said second radio client (3a, 3b, 4a, 4b, 4c), wherein
each second radio client (3a, 3b, 4a, 4b, 4c) communicates the received frequency-dependent measurement signals to the first radio client (2),
the first radio client (2) has a display unit (6), and the frequency-dependent measurement signals of the second radio clients (3a, 3b, 4a, 4b, 4c) are depicted by said display unit (6), and
the measurement signals of the different second radio clients (3a, 3b, 4a, 4b, 4c) are displayed in superimposed fashion.

24. Process according to claim 23, where each second radio client (3a, 3b, 4a, 4b, 4c) switches from a communication mode into the diagnosis mode and back into the communication mode, and each second radio client (3a, 3b, 4a, 4b, 4c) communicates with the radio clients (2, 3a, 3b, 4a, 4b, 4c) in the communication mode and in the diagnosis mode the communication with other radio clients (2, 3a, 3b, 4a, 4b, 4c) is suspended.

25. Process according to claim 24, where each second radio client (3a, 3b, 4a, 4b, 4c) switches out of the diagnosis mode and returns to the communication mode after the expiration of a predetermined period of time.

26. Process according to claim 23, where each second radio client (3a, 3b, 4a, 4b, 4c) runs though the two channels a number of times while in the diagnosis mode.

27. Process according to claim 24, where each second radio client (3a, 3b, 4a, 4b, 4c) switches into the communication mode and communicates the measurement signals to the first radio client (2) while in the communication mode.
